(19) United States
(12) Patent Application Publication
(10) Pub. No.: US 2010/0048178 A1
(43) Pub. Date: Feb. 25, 2010

(54) Method and apparatus for deleting message in mobile terminal

(75) Inventors: Eun-Young Song, Seoul (KR); Nam-Hoon Kim, Suwon-si (KR); Dae-Hyun Sim, Seoul (KR); Sung Kwon, Anyang-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/583,280

(22) Filed: Aug. 18, 2009

(30) Foreign Application Priority Data
Aug. 21, 2008 (KR) 10-2008-0082098

(51) Int. Cl. H04W 4/12

(52) U.S. Cl. 455/412.1

(57) ABSTRACT

A method and an apparatus efficiently deletes messages from a memory in a mobile terminal. In the method, a service message is received. Importance of the received service message is calculated. When there is no spare space for storing the received service message, a predetermined number of previously stored service messages are displayed according to importance of a message. At least one of the displayed service messages is selected and deleted.

### CROSS-REFERENCE TO RELATED APPLICATION(S) AND CLAIM OF PRIORITY

The present application is related to and claims the benefit under 35 U.S.C. § 119 to an application filed in the Korean Intellectual Property Office on Aug. 21, 2008 and assigned Serial No. 10-2008-0082098, the contents of which are incorporated herein by reference.

### TECHNICAL FIELD OF THE INVENTION

The present invention relates generally to a method and an apparatus for deleting a message in a mobile terminal, and more particularly, to a method and an apparatus for recommending a message to be deleted with consideration of importance of the message in a mobile terminal.

### BACKGROUND OF THE INVENTION

Generally, a mobile terminal can perform communication of Short Message Service (SMS) messages or image messages besides voice communication. When the SMS message is received, it is stored in a built-in memory of a mobile terminal, and a user may select and display the received SMS message on a display unit when needed. Also, in addition to the SMS message, a Multimedia Message Service (MMS) message, which is a message service integrating a moving image, a photo, and a music file, increases memory storage requirements.

Therefore, to allow a mobile terminal to store the above-described messages, the capacity of a memory increases more and more. At this point, messages stored in the memory may be deleted by a user's selection. To delete a message stored in a memory of a conventional mobile terminal, a method of selecting and deleting a message to be deleted one by one, or a method of collectively deleting all stored messages has been used. However, since the former message deleting method should select and delete a message to be deleted one by one, a procedure of deleting a message is inconvenient. Also, since the latter message deleting method deletes all messages, this method cannot be used in the case where there exists a message which a user does not desire to delete.

Therefore, a method and an apparatus for efficiently deleting a message in a mobile terminal are required.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide a method and an apparatus for efficiently deleting a message in a mobile terminal.

Another aspect of the present invention is to provide a method and an apparatus for allowing a user to recommend a message to be deleted through a menu (or a pop-up) when a storage space for storing messages is insufficient in a mobile terminal.

According to an aspect of the present invention, a method for deleting a message in a mobile terminal is provided. The method includes: receiving a service message; calculating importance of the received service message; when there is no spare space for storing the received service message, displaying a predetermined number of previously stored service messages according to importance of a message; and selecting and deleting at least one of the displayed service messages.

According to another aspect of the present invention, a method for deleting a message in a mobile terminal is provided. The method includes: displaying previously stored service messages according to importance of a message during a relevant period; and selecting and deleting at least one of the displayed service messages.

According to yet another aspect of the present invention, a method for deleting a message in a mobile terminal is provided. The method includes: when a service message is received, determining whether there is a spare space for storing the service message; when there is no spare space for storing the received service message, displaying a predetermined number of previously stored service messages according to importance of a message; and selecting and deleting at least one of the displayed service messages.

According to further another aspect of the present invention, an apparatus for deleting a message in a mobile terminal is provided. The apparatus includes: a receiver for receiving a service message; a message importance calculator for calculating importance of the received service message; a display unit for, when there is no spare space for storing the received service message, displaying a predetermined number of previously stored service messages according to importance of a message; and a controller for selecting and deleting at least one of the displayed service messages.

According to still another aspect of the present invention, an apparatus for deleting a message in a mobile terminal is provided. The apparatus includes: a display unit for displaying previously stored service messages according to importance of a message during a relevant period; and a controller for selecting and deleting at least one of the displayed service messages.

According to still another aspect of the present invention, an apparatus for deleting a message in a mobile terminal is provided. The apparatus includes: a controller for, when a service message is received, determining whether there is a spare space for storing the service message; and a display unit for, when there is no spare space for storing the received service message, displaying a predetermined number of previously stored service messages according to importance of a message, wherein the controller selects and deletes at least one of the displayed service messages.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of certain exemplary embodiments of the present invention will be more apparent from the following description taken in conjunction with the accompanying drawings in which:

FIG. 1 illustrates a flowchart of recommending and deleting a message with consideration of importance of a message in a mobile terminal according to an exemplary embodiment of the present invention;

FIG. 2 illustrates a flowchart of recommending and deleting a message with consideration of importance of a message in a mobile terminal according to another exemplary embodiment of the present invention;

FIG. 3 illustrates a block diagram illustrating a mobile terminal recommending and deleting a message with consideration of importance of a message according to an exemplary embodiment of the present invention;

FIG. 4A illustrates a view illustrating a screen displaying the state of a received mailbox;

FIG. 4B illustrates a view listing messages to be deleted according to importance;

FIG. 5A is a view illustrating a screen in which a user selects and deletes one of displayed messages; and

FIG. 5B is a view illustrating a screen in which a user selects and deletes all displayed messages.

### DETAILED DESCRIPTION OF THE PREFERRED EMBODIMENTS

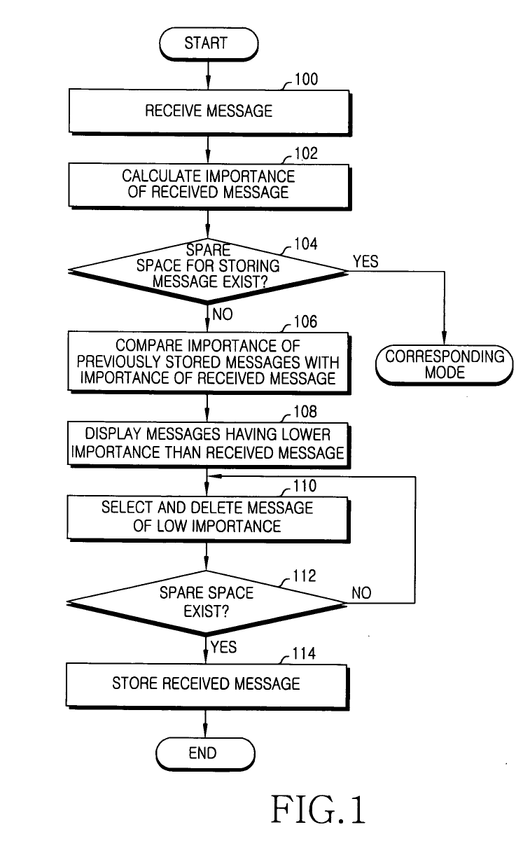

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will be described herein below with reference to the accompanying drawings. In the following description, well-known functions or constructions are not described in detail since they would obscure the invention in unnecessary detail. Terminologies described below are defined with consideration of functions in the present invention, and can change depending on the intention or practice of a user or operator. Therefore, the definitions should be determined on the basis of the descriptions over the specification.

Exemplary embodiments of the present invention provide a method and an apparatus for recommending and deleting a message with consideration of importance of a message in a mobile terminal.

FIG. 1 illustrates a flowchart of recommending and deleting a message with consideration of importance of a message in a mobile terminal according to an exemplary embodiment of the present invention.

Referring to FIG. 1, in step 100, the mobile terminal receives an SMS message or an MMS message.

In step 102, the mobile terminal calculates importance of the received message. Here, the importance of the message is calculated with consideration of necessary factors below.

First, the mobile terminal calculates the importance of a message with consideration of “ClosenessWeight” representing a closeness degree calculated using a user's SMS use history or MMS use history, and a call log, “ReadCountWeight”, which is a weight applying a read frequency of a relevant message, and “TextDataSizeWeight”, which is a weight applying a data size of a relevant message. The mobile terminal may determine importance by considering all of ClosenessWeight, ReadCountWeight, and TextDataSizeWeight depending on embodiment and a user's selection, or determine importance by considering only one of ClosenessWeight, ReadCountWeight, and TextDataSizeWeight, or determine importance by combining two values of ClosenessWeight, ReadCountWeight, and TextDataSizeWeight.

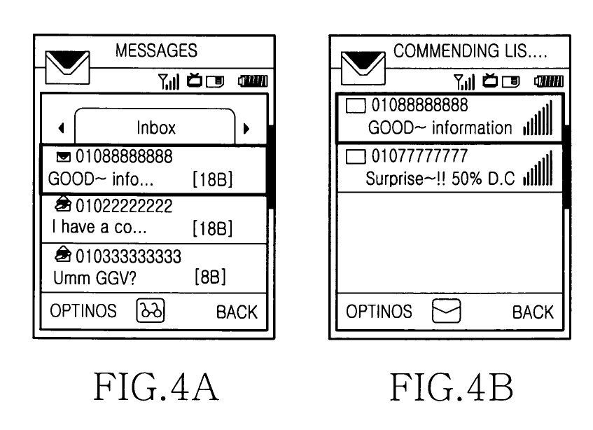

When a space for storing messages (for example, a mail storing box) is insufficient in step 104, the mobile terminal proceeds to step 106. When the space for storing messages is sufficient, the mobile terminal performs a corresponding mode and stores a received message together with the calculated importance of the message according to a predetermined procedure. FIG. 4A illustrates a screen of a received mailbox.

In step 106, the mobile terminal compares the importance of previously stored messages with the importance of a received message, and in step 108, lists and displays previously stored messages having lower importance than the importance of the received message. FIG. 4B illustrates a screen which lists messages to be deleted according to importance. Here, the calculated importance of recommended messages to be deleted is displayed using a numerical value or graph so that a user may recognize the importance.

According to another embodiment, when the space for storing messages is insufficient in step 104, the mobile terminal may display a predetermined number of previously stored messages in a low importance order without comparing the importance of the previously stored messages with the importance of the received message in step 106 (not specifically illustrated).

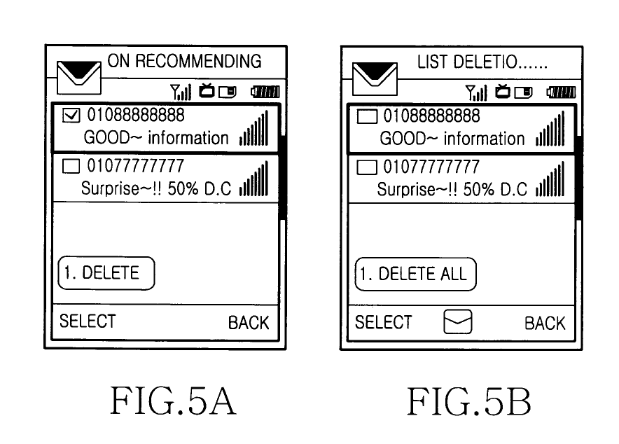

In step 110, the mobile terminal may select and delete any message of the displayed messages. FIG. 5A illustrates a user selects and deletes one of displayed messages, and FIG. 5B illustrates a user selects and deletes all displayed messages.

When the space is insufficient even after the recommended message is deleted in step 112, the mobile terminal proceeds to step 110 again.

Conversely, when the space for storing a received message is sufficient in step 112, the mobile terminal stores the received message in a relevant memory region (step 114).

After that, the mobile terminal ends a message deleting procedure.

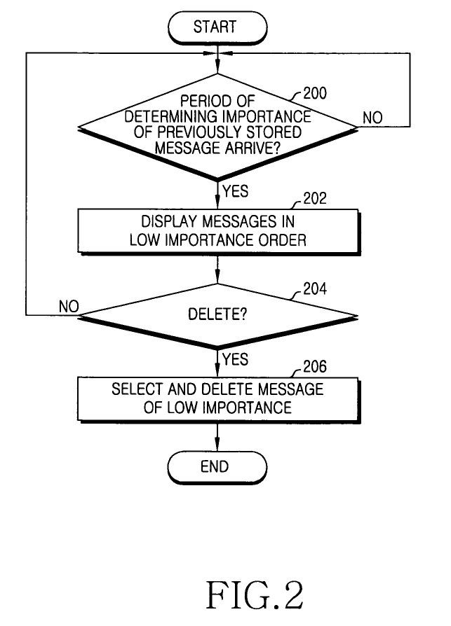

In FIG. 1, in the case where the mobile terminal receives an SMS message or an MMS message, the mobile terminal displays a message to be deleted according to importance, and a user selects and deletes the message. According to an exemplary embodiment of the present invention, the mobile terminal may display messages to be deleted according to importance every preset period even when an SMS message or an MMS message is not received, and a user may select and delete the message, which will be described in detail with reference to FIG. 2.

FIG. 2 illustrates a flowchart of recommending and deleting a message with consideration of importance of a message in a mobile terminal according to another exemplary embodiment of the present invention.

Referring to FIG. 2, when a period of determining importance of previously stored messages and displaying the importance on a screen arrives in step 200, the mobile terminal displays messages to be deleted in a low importance order (step 202). The period may be determined by a user's setting.

In step 204, the mobile terminal determines whether there are messages to be deleted in the displayed recommended messages. When there is no message to be deleted, the mobile terminal performs step 200. Conversely, when there are messages to be deleted in the displayed recommended messages, the mobile terminal deletes selected messages (step 206).

After that, the mobile terminal ends a message deleting procedure.

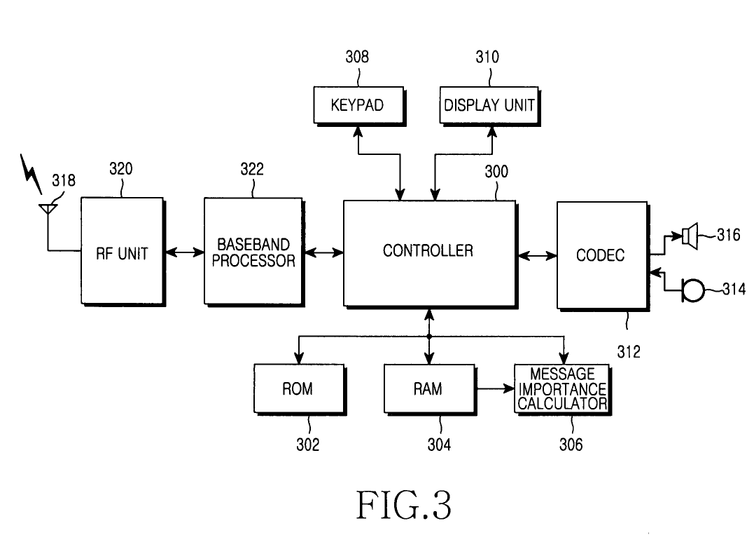

FIG. 3 illustrates a block diagram illustrating a mobile terminal recommending and deleting a message with consideration of importance of a message according to an exemplary embodiment of the present invention.

Referring to FIG. 3, a controller 300 controls an overall operation of the mobile terminal. For example, the controller 300 performs a process and a control for voice communication and data communication. Descriptions of the general process and control of the controller 300 are omitted.

According to an exemplary embodiment of the present invention, when a space (for example, a mail storing box) for storing messages is insufficient upon reception of a message, the controller 300 compares the importance of previously stored messages with the importance of the received message, and lists and displays previously stored messages having lower importance than the importance of the received message. Here, the calculated importance of recommended messages to be deleted is displayed so that a user may recognize the importance.

When the space for storing messages is sufficient, the controller 300 performs a relevant mode and stores a received message together with the calculated importance according to a predetermined procedure.

Also, according to another embodiment, when the space for storing messages is insufficient, the controller 300 may display a predetermined number of previously stored messages in a low importance order without comparing the importance of the previously stored messages with the importance of the received message.

The controller 300 selects and deletes a relevant message of the displayed messages. When the space for storing messages is insufficient even after a recommended message is deleted, the controller 300 displays a recommended message according to importance of a message again. Also, when the space for storing messages is sufficient, the controller stores a received message in a relevant memory region.

Also, according to another embodiment, when a period of determining importance of messages previously stored in Random Access Memory (RAM) 304 and displaying the messages arrives, the controller 300 displays the messages to be deleted in a low importance order. The period may be determined by a user's setting.

When the controller 300 receives an SMS message or an MMS message, a message importance calculator 306 calculates the importance of the received message. Here, the importance of the message is calculated with consideration of necessary factors below. First, the controller 300 calculates the importance of a message with consideration of “ClosenessWeight” representing a closeness degree calculated using a user's SMS use history or MMS use history, and a call log, “ReadCountWeight”, which is a weight applying a read frequency of a relevant message, and “TextDataSizeWeight”, which is a weight applying a data size of a relevant message. The mobile terminal may determine importance by considering all of ClosenessWeight, ReadCountWeight, and TextDataSizeWeight depending on embodiment and a user's selection, or determine importance by considering only one of ClosenessWeight, ReadCountWeight, and TextDataSizeWeight, or determine importance by combining two values of ClosenessWeight, ReadCountWeight, and TextDataSizeWeight.

Read Only Memory (ROM) 302 stores microcodes of a program for process and control of the controller 300, and various reference data. Also, the ROM 302 stores various updatable data for storage such as a phone book, originating messages, and received messages.

The RAM 304 serves as a working memory of the controller 300, and stores temporary data generated while the controller 300 executes various programs.

A keypad 308 includes a plurality of function keys such as numerical keys ‘0’ to ‘9’, a menu key, a cancel (delete) key, an OK key, a TALK key, an END key, an Internet access key, and a navigation key (or arrow key), and provides key input data corresponding to a key pressed by a user to the controller 300.

A display unit 310 displays state information generated during an operation of the mobile terminal, a limited number of letters, and a large amount of moving images and still images. A color Liquid Crystal Display (LCD) can be used as the display unit 310. For example, according to an exemplary embodiment of the present invention, the display unit 310 provides a screen allowing a user's selection by displaying recommended messages to be deleted which are provided by the controller 300.

A Coder-Decoder (CODEC) 312 connected with the controller 300, a speaker 316 connected to the CODEC 312, and a microphone 314 serve as a voice input/output block used for telephone communication and voice recording.

The CODEC 312 converts Pulse Code Modulation (PCM) data provided by the controller 300 to an analog voice signal and transmits the voice signal via the speaker 316, and converts a voice signal received via the microphone 314 to PCM data and provides the PCM data to the controller 300.

Also, a Radio Frequency (RF) unit 320 down-converts an RF signal received via an antenna 318 to provide the down-converted signal to a baseband processor 322, and up-converts a baseband signal from the baseband processor 322 to transmit the up-converted signal via the antenna 318.

The baseband processor 322 processes a baseband signal transmitted and received between the RF unit 320 and the controller 300. For example, during transmission, the baseband processor 322 channel-codes and spreads data to be transmitted, and during reception, despreads and channel-decodes a received signal.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for deleting a message in a mobile terminal, the method comprising:
receiving a service message;
calculating importance of the received service message;
displaying a predetermined number of previously stored service messages according to importance of a message, when there is no spare space for storing the received service message; and
selecting and deleting at least one of the displayed service messages.

2. The method of claim 1, wherein the importance of the message is calculated with consideration of at least one of “ClosenessWeight” representing a closeness degree calculated using a user's Short Message Serviceuse history or Multimedia Message Serviceuse history, and a call log, “ReadCountWeight” which is a weight applying a read frequency of a relevant message, and “TextDataSizeWeight” which is a weight applying a data size of a relevant message.

3. The method of claim 1, further comprising, when there is a spare space for storing the received service message, storing the received service message together with the calculated importance of the message.

4. The method of claim 1, further comprising, after the selecting and deleting of the at least one of the displayed service messages, storing the received service message together with the calculated importance of the message.

5. The method of claim 1, wherein the service message comprises a Short Message Service or a Multimedia Message Service.

6. A method for deleting a message in a mobile terminal, the method comprising:
displaying previously stored service messages according to importance of a message during a preset period; and
selecting and deleting at least one of the displayed service messages.

7. The method of claim 6, wherein the previously stored service messages are stored together with calculated importance of the messages while they are received.

8. The method of claim 6, wherein the importance of the message is calculated with consideration of at least one of “ClosenessWeight” representing a closeness degree calculated using a user's Short Message Serviceuse history or Multimedia Message Service use history, and a call log, “ReadCountWeight” which is a weight applying a read frequency of a relevant message, and “TextDataSizeWeight” which is a weight applying a data size of a relevant message.

9. A method for deleting a message in a mobile terminal, the method comprising:
determining whether there is a spare space for storing the service message, when a service message is received;
displaying a predetermined number of previously stored service messages according to importance of a message, when there is no spare space for storing the received service message; and
selecting and deleting at least one of the displayed service messages.

10. The method of claim 9, further comprising calculating the importance of the message, wherein the importance of the message is calculated with consideration of at least one of “ClosenessWeight” representing a closeness degree calculated using a user's Short Message Service use history or Multimedia Message Service use history, and a call log, “ReadCountWeight” which is a weight applying a read frequency of a relevant message, and “TextDataSizeWeight” which is a weight applying a data size of a relevant message.

11. An apparatus for deleting a message in a mobile terminal, the apparatus comprising:
a receiver for receiving a service message;
a message importance calculator for calculating importance of the received service message;
a display unit for displaying a predetermined number of previously stored service messages according to importance of a message, when there is no spare space for storing the received service message; and
a controller for selecting and deleting at least one of the displayed service messages.

12. The apparatus of claim 11, wherein the importance of the message is calculated with consideration of at least one of “ClosenessWeight” representing a closeness degree calculated using a user's Short Message Service use history or Multimedia Message Service use history, and a call log, “ReadCountWeight” which is a weight applying a read frequency of a relevant message, and “TextDataSizeWeight” which is a weight applying a data size of a relevant message.

13. The apparatus of claim 11, wherein when there is a spare space for storing the received service message, the controller stores the received service message together with the calculated importance of the message.

14. The apparatus of claim 11, wherein after the selecting and deleting of the at least one of the displayed service messages, the controller stores the received service message together with the calculated importance of the message.

15. The apparatus of claim 11, wherein the service message comprises a Short Message Service or a Multimedia Message Service.

16. An apparatus for deleting a message in a mobile terminal, the apparatus comprising:
a display unit for displaying previously stored service messages according to importance of a message during a preset period; and
a controller for selecting and deleting at least one of the displayed service messages.

17. The apparatus of claim 16, wherein the previously stored service messages are stored together with calculated importance of the service messages while they are received initially.

18. The apparatus of claim 16, wherein the importance of the message is calculated with consideration of at least one of “ClosenessWeight” representing a closeness degree calculated using a user's Short Message Service use history or Multimedia Message Service use history, and a call log, “ReadCountWeight” which is a weight applying a read frequency of a relevant message, and “TextDataSizeWeight” which is a weight applying a data size of a relevant message.

19. An apparatus for deleting a message in a mobile terminal, the apparatus comprising:
a controller for, when a service message is received, determining whether there is a spare space for storing the service message; and
a display unit for, when there is no spare space for storing the received service message, displaying a predetermined number of previously stored service messages according to importance of a message,
wherein the controller selects and deletes at least one of the displayed service messages.

20. The apparatus of claim 19, further comprising a message importance calculator for calculating importance of a message, wherein the importance of the message is calculated with consideration of at least one of “ClosenessWeight” representing a closeness degree calculated using a user's Short Message Service use history or Multimedia Message Service use history, and a call log, “ReadCountWeight” which is a weight applying a read frequency of a relevant message, and “TextDataSizeWeight” which is a weight applying a data size of a relevant message.

21. A computer-readable recording medium having recorded thereon a program for deleting a message in a mobile terminal, comprising:
a first code segment, for receiving a service message;
a second code segment, for calculating importance of the received service message;
a third code segment, for displaying a predetermined number of previously stored service messages according to importance of a message, when there is no spare space for storing the received service message; and
a fourth code segment, for selecting and deleting at least one of the displayed service messages.

22. A computer-readable recording medium having recorded thereon a program for deleting a message in a mobile terminal, the apparatus comprising:
a first code segment, for displaying previously stored service messages according to importance of a message during a preset period; and
a second code segment, for selecting and deleting at least one of the displayed service messages.

23. A computer-readable recording medium having recorded thereon a program for deleting a message in a mobile terminal, the apparatus comprising:
a first code segment, for determining whether there is a spare space for storing a service message when the service message is received; and
a second code segment, for displaying a predetermined number of previously stored service messages according to importance of a message when there is no spare space for storing the received service message,
wherein the controller selects and deletes at least one of the displayed service messages.
